(19) United States
(12) Patent Application Publication
(10) Pub. No.: US 2006/0084707 A1
(43) Pub. Date: Apr. 20, 2006

(54) Methods for manufacture of aerogels

(75) Inventors: Duan Li Ou, Northborough, MA (US); Hai Ching Lee, Worcester, MA (US); George L. Gould, Mendon, MA (US); Yue Hua Tang, Gardner, MA (US)

Correspondence Address: Aspen Aerogels Inc.;IP Department, Building B, 30 Forbes Rd, Northborough, MA, 01532, US

(73) Assignee: Aspen Aerogels, Inc., Northborough, MA (US)

(21) Appl. No.: 11/251,079

(22) Filed: Oct. 14, 2005

Related U.S. Application Data
(60) Provisional application No. 60/619,506, filed on Oct. 15, 2004.

(51) Int. Cl. B01F 3/12; C01B 33/12; B32B 3/26

(52) U.S. Cl. 516/78; 423/339; 423/592.1; 428/312.2

(57) ABSTRACT

Embodiments of the present invention describe a method for producing gel beads comprising: depositing catalyzed sol droplets comprising a gel precursor into a moving dispensing medium, said medium being immiscible with the sol, and allowing gelation of the sol to occur in the moving dispensing medium thereby producing gel beads. This system utilizes a horizontally flowing dispensing medium where the catalyzed sol droplet is fully formed before deposited therein.

### PRIORITY

This application claims priority from U.S. Provisional application Ser. No. 60/619,506 filed Oct. 15, 2004.

### GOVERNMENT INTEREST

None

Low-density aerogel materials (0.01-0.3 g/cc) are widely considered to be the best solid thermal insulators, better than the best rigid foams with thermal conductivities of 10 mW/m-K and below at 100° F. and atmospheric pressure. Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well at cryogenic temperatures to 550° C. and above. Aerogel materials also display many other interesting acoustic, optical, mechanical, and chemical properties that make them abundantly useful.

The methods described in embodiments of the represent significant advances in gel processing that will facilitate production of these aerogel materials, especially in particulate form such as beads. Beads for the purposes of the present description describe spherical or nearly spherical shapes.

Unlike irregular shape aerogel powder and granulate, aerogel beads needed to be produced in its shape prior to CO₂ supercritical extraction. This shaping step must take place during the formation of gel.

Gels as described in the present disclosure typically refer to porous materials containing a liquid in the pores. Such liquids can comprise alcohols, water, aqueous media, ethanol, ether and any combination thereof. In order to produce a gel, a sol must be brought to gelation in order to build up its network structure [R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3.]. The time duration of this event vary from a few seconds to couple of days. Since the shaping stage takes place in this time period in order to guarantee the spherical (or near spherical) macroscopic form, it must be attuned to the respective gelation time. Mainly two types of approach were found in the literature for forming gels and subsequent aerogel beads. In this respect, a distinction is made between both methods in which the hydrolyzed sol is brought either into a vapor or into a liquid phase.

Described in GB773549 is a process in which a methyl alcoholic silicic acid sol is pumped into a 270° C. seal steel column, leading to a mixture of silica gel and methyl alcohol vapor. Sub-micron size silica aerogel particles were formed of toxic solvents at a very high temperatures and pressures and ability and is limited in the size of resulting beads.

Described in U.S. Pat. No. 3,872,217 is a method in which silicic acid containing solution is sprayed into a gaseous medium through a special mixing nozzle to produce droplets. This results in relatively larger sized (>4 mm) and higher density products. Furthermore the dropping distance has to be matched with the gelation time. Obtaining a narrow size distribution can be difficult in this process.

Described in U.S. Pat. No. 207,950 and WO9936354 is a process in which the hydrosol was dropped into a long vertical column filled with hexamethyldisiloxane (HMDSO). The gel beads are formed and surfaced modified in the HMDSO solution. Here, a long column is required for any larger scale production. It is generally difficult to remove HMDSO inside the gel beads during the subsequent processing. Only millimeter size beads were shown in the example of this patent.

Embodiments of the present invention describe methods for an effective and high capacity gel beads making method. Traditional approaches can require long columns that must be filled with hot air or hazardous materials. It costs substantially less to build a gel bead making plant due to the space efficiency of the required apparatuses of the present invention. Embodiments of the present invention allow for improved size distribution control of the final beads and in ranges of microns and above. gel beads can be made in a continuous or semi-continuous manner according to embodiments of the present invention. When gallons of gel beads continuously are produced in this bead making equipment, followed by the fast CO₂ extraction process, the production footprint is diminished even further, resulting in increasing production capacity and potentially lowering production cost relative to other bead making methods.

### SUMMARY OF THE INVENTION

Embodiments of the present invention describe a method for producing gel beads comprising: depositing catalyzed sol droplets comprising a gel precursor into a dispensing medium, said dispensing medium being immiscible with the sol, and allowing gelation of the sol to occur in the dispensing liquid medium thereby producing gel beads. This system utilizes a horizontally flowing dispensing medium where the catalyzed sol droplet is fully formed before deposited therein.

### DESCRIPTION OF THE DRAWINGS

FIG. 1 is a perspective view of a bead preparation apparatus.

FIG. 2 is an image of aerogel beads prepared according to embodiments of the present invention.

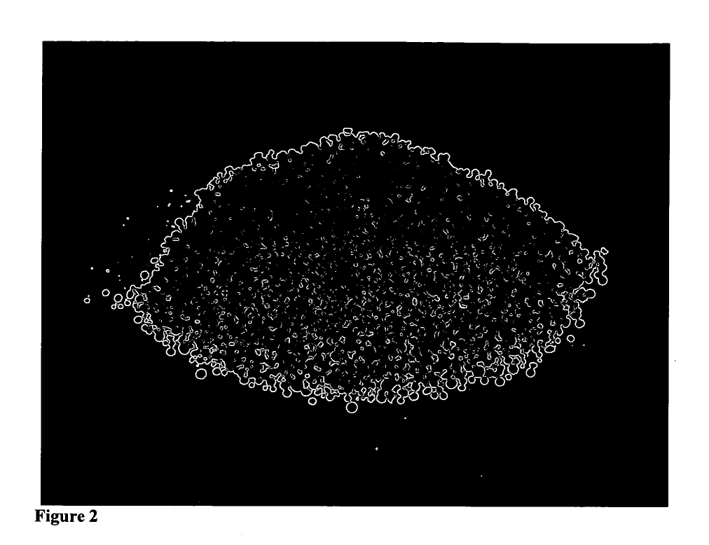

FIG. 3 is an SEM image illustrating bead sizes prepared in the micron ranges.

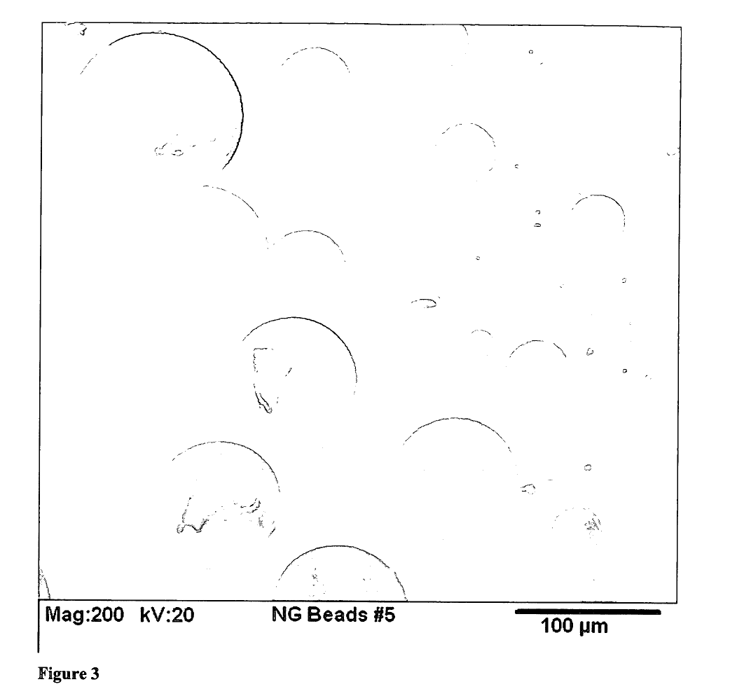

FIG. 4 is an SEM image illustrating the general shape of the prepared beads.

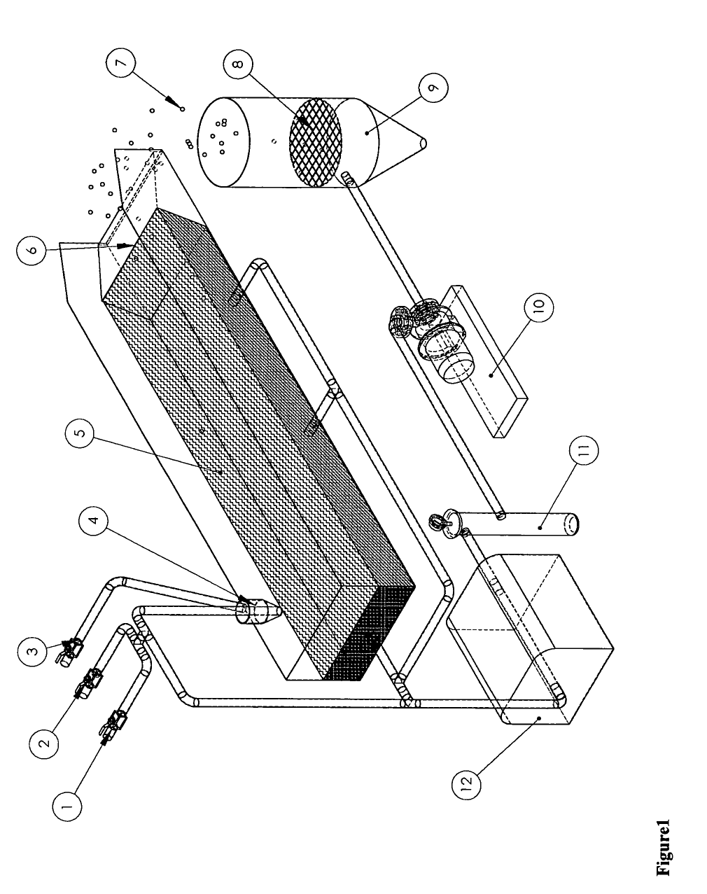

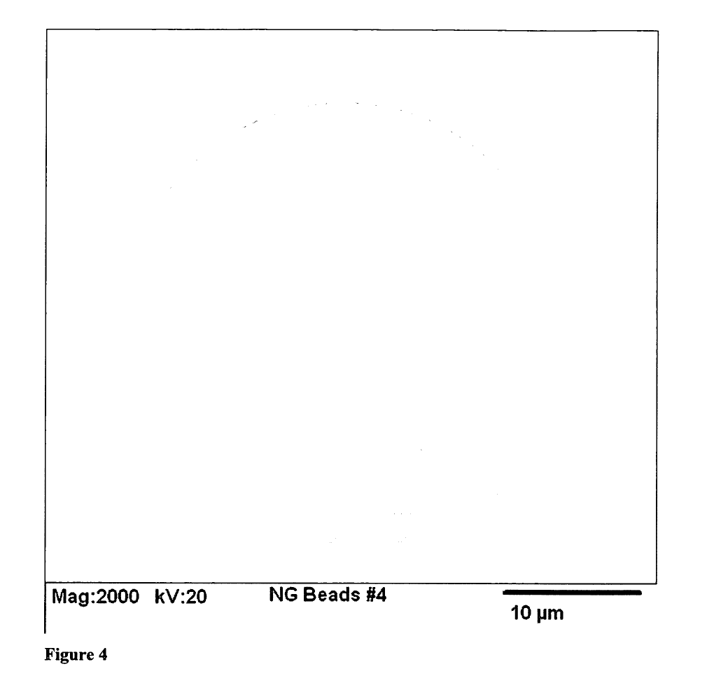

FIG. 1 illustrates a method that produces gel beads in a continuous or semi-continuous fashion utilizing a sol dispensing and catalyst mixing system and a horizontal-flow silicone-oil filled trough. gel beads can be collected in batch form with a filter bag attached to the end of the oil trough. The production capacity of the equipment inherent in the present invention, even at a small footprint of 4 square foot can be as high as 20 liters/hour. The numbers in the schematic correspond to the following: The control valve 1 supplies the stable sol precursor solution. The control valve 2 introduces the catalyst solution supply designed to deliver in controllable quantities. The auxiliary control valve 3 controls supply of liquid medium (such as one matching the flowing medium) or compressed air, both of which can be used to produce a sol spray and yielding smaller gel beads. The mixing nozzle system 4 allows mixing and dispensing of sol. In order to accommodate the short gelation time described in the current process (3-20 Sec), a static mixer is placed inside a dispensing nozzle. gel beads with reasonably narrow size distributions can be fabricated in the average diameter range of 0.05 mm to 4 mm using this nozzle. This unit is inexpensive and easy to maintain for replacement parts and cleaning. The nozzle is attached to a moveable holder that can be adjusted to the appropriate position, orifice and angle for controlling bead size. The horizontal oil trough 5 and oil flow control system handle the dispensing medium. In one example, the oil trough dimensions are 50 inches long, 5 inches wide and 4 inches high. The dwell time of gel beads in the oil trough is designed to be less than about 60 seconds or less than about 50 seconds or less than 40 seconds or less than 30 seconds or less than 20 seconds or less than 10 seconds. A guide plane and multiple oil injection nozzles are placed inside the oil trough to control the oil flow, which allows the gel beads to travel through the oil trough smoothly. This tiny trough could produce 10 to 20 L of gel beads per hour, and needs as little as 5 gallons silicone oil to maintain the circulation flow. The dispensing medium 6 is non-miscible to the catalyzed sol droplets. Typical example of dispensing medium is silicone oil. The gel beads are labeled 7. The gel bead/oil separation system 8 can be fixed or continuous. When the gel beads reach the end of the trough, they flow into a bead/oil separation system. For batch production, only a filter bag is needed to collect the gel beads and separate them away from the carrier silicone oil, which is returned to the oil trough for further use. The container 9 houses the gel bead/oil separation system. The pump, 10 aids in circulation of the dispensing medium. Unit 11 is the filter and 12 is the temperature control system (typically a heater unit). The silicone oil is first pumped into a filter by a centrifugal pump to remove most of the fine particles, and then past the heater unit to maintain its temperature at a desirable level.

### DESCRIPTION OF EMBODIMENTS OF THE INVENTION

Gels are a class of materials formed by entraining a mobile interstitial solvent phase within the pores of a solid structure. The solid structures can be composed of inorganic, organic or inorganic/organic hybrid polymer materials that develop a pore morphology in direct relation to the method of gelation, solvent-polymer interactions, rate of polymerization and cross-linking, solid content, catalyst content, temperature and a number of other factors. It is preferred that gel materials are formed from precursor materials, including various opacification materials that block thermal radiation of the resulting gel, in a continuous or semi-continuous fashion in the form of spherical particles such that the interstitial solvent phase can be readily removed by supercritical fluids extraction to make an aerogel material. By keeping the solvent phase above the critical pressure and temperature during the entire, or at minimum, until the end of the solvent extraction process, strong capillary forces generated by liquid evaporation from very small pores that cause shrinkage and pore collapse are not realized. Within the context of embodiments of the present invention “aerogels” or “aerogel materials”, refer to gels containing air as a dispersion medium in a broad sense and include, aerogels, xerogels and cryogels in a narrow sense. Suitable aerogels in some embodiments may have densities between about 0.03 to about 0.3 g·cm³ Aerogels can also have very high surface areas (generally from about 300 to 1000 m²/g and higher, preferably about 700 to 1000 m²/g), high porosity (about 90% and greater, preferably greater than about 95%), and relatively large pore volume (about 3 mL/g, preferably about 3.5 mL/g and higher). In some cases the thermal conductivity values are between about 9 to 25 mW/m-K at 37° C. and 1 atmosphere of pressure).

The gel bead making methods described in the present invention comprise three distinct steps. The first is blending all constituent components (solid precursor, dopants, and additives) into a low-viscosity stable sol, and mix it with a catalyst solution by a Y junction before it reaches the dispensing nozzle.

The second step involves dispensing the catalyzed sol onto a flowing dispensing medium which is non-miscible with the sol. Silicone oil is the preferred dispensing medium in this case. This step can be carried out by a nozzle, with or without the injection of compressed air. The droplet size of the sol can thereby be adjusted for instance according to the manner of its introduction into the dispensing medium or silicone oil in the preferred embodiment. This can be realized by controlling the following parameter in the invented bead making equipment:

The diameter of the nozzle opening

Flow rate of the catalyzed sol

Flow rate of the silicone oil

The distance and angle of the nozzle to the surface of the dispensing medium silicone oil.

The flow rate of compressed air or silicone oil, and the distance of between the sol nozzle and the air/oil outlet (where production of beads in ranges of about 0.1 to 0.5 is concerned)

Spherical sol droplets thus form in the silicone oil by virtue of the interface tension. The sol droplets gel and rigidify themselves during their stay in the silicone oil, which flows horizontally and prevent the sol droplet from agglomeration. The second step may also include introduction of heat or radiation to the moving dispensing medium silicone oil to induce or enhance gelation to the sol droplets or rigidify the gel beads and make them strong enough to resist collision.

The production capacity of gel beads in a given space depends upon the precise control of the gelation process of sol droplets. In an embodiment gelation time is matched with the residence time of sol droplets or gel beads inside the flowing silicone oil.

Therefore, gelation time defines the length of the flowing silicone oil, thus the dimension of the bead-dispensing vessel. In order to achieve the maximum production capacity in a given space, the gelation time is needed to be controlled precisely. In preferred embodiments, they need to be in the order of several seconds.

The third step of the process involves removing gel beads from silicone oil and optional surface modification of the gel beads. The gel beads are collected into a filter bag with approximately 1.5 to 2 L batch size at the end of dispensing vessel and placed into a conical container. It is further washed or rinsed with fluids such as THF or alcohols like ethanol, methanol, isopropanol, and higher alcohols. A basic requirement for the rinsing liquid is that it can remove the oil (or other dispensing medium) while not reacting chemically with the gel. After removal of excess amount of silicone oil, the bags of gel beads are placed into a silylating agent such as HMDS container for optional surface trimethysilylation. The gel beads or the surface of modified beads are amenable to interstitial solvent removal using supercritical fluid drying methods. They may also be dried at ambient pressures to make xerogels. As the filter bags are made with permeable layers, they allow supercritical fluid and organic solvents inside the gel beads to pass easily during the extraction process.

The gel material precursors for embodiments of the present invention may be organic, inorganic, or a mixture thereof. Sols can be catalyzed to induce gelation by several methods. Examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3; the above mentioned references are incorporated here by reference). Suitable materials for forming inorganic aerogels are oxides of most of the metals that can form oxides, such as silicon, aluminum, titanium, zirconium, hafnium, yttrium, vanadium, and the like. Various polymers can also be combined with the metal oxide matrix to form inorganic/organic hybrid aerogel. In another embodiment, polymers may themselves form the sol and the resultant aerogel matrix. Particularly preferred are gels formed primarily from alcohol solutions of hydrolyzed silicate esters with or without polymers.

Polymers suitable for the preparation of inorganic/organic hybrid aerogels includes, but not limited to polyacrylates, polymethacrylate, polystyrenes, polyacrylonitriles, polyurethanes, polyamides, polyimides, polycyanurates, polyacrylamides, various epoxies, agar, agarose, and the like.

In one embodiment, various forms of electromagnetic, acoustic, or particle radiation sources can be used to induce gelation of sol precursor materials in the silicone oil. Heat, ultrasonic energy, ultraviolet light, gamma radiation, electron beam radiation, and the like can be exposed to a sol material to induce gelation. Energy dissipation (heat, acoustic, radiation) into a fixed zone of the conveyor apparatus, such that a moving sol pool interacts with a controlled energy flux for a fixed period of time is advantageous for controling the properties of the gel as well as the dried aerogel or xerogel material.

Principal synthetic route for the formation of an inorganic aerogel may be the hydrolysis and condensation of an appropriate metal alkoxide. The principal synthetic route for the formation of an inorganic/organic aerogel may be the hydrolysis and condensation of an appropriate metal alkoxide. In a one embodiment, a polymer containing hydrolysable functional group can be added. The most suitable metal alkoxides are those having about 1 to 6 carbon atoms, preferably from 1-4 carbon atoms, in each alkyl group. Specific examples of such compounds include tetraethoxysilane (TEOS), tetramethoxysilane (TMOS), tetra-n-propoxysilane, aluminum isopropoxide, aluminum sec-butoxide, cerium isopropox-ide, hafnium tert-butoxide, magnesium aluminum isopropoxide, yttrium isopro-poxide, titanium isopropoxide, zirconium isopropoxide, and the like. In the case of silica precursors, these materials can be partially hydrolyzed and stabilized at low pH as polymers of polysilicic acid esters such as polydiethoxysiloxane. These materials are commercially available in alcohol solution from vendors such as Degussa Coporation, Silbond Corporation etc). Pre-polymerized silica precursors are especially preferred for the processing of gel materials described in this invention. The most suitable hydrolysable polymer is alkoxysilyl-containing polymer. Specific examples of such compounds include trimethoxysilyl-containing polymethylmethacrylate, triethoxysilyl-containing polymethmethacrylate, and trimethoxysilyl containing polybutylmethacrylate, triethoxysilyl containing polybutylmethacrylate, and the like. These trialkoxylsilyl containing polymethacrylate polymers were synthesized from methacrylate monomer, together with trimethoxysilylpropylmethacrylate. The methacrylate monomer includes and not limit to methylmethacrylate (referred as MMA there after), ethylmethacrylate (referred as EMA there after), butylmethacrylate (referred as BMA there after), hydroxyethylmethacrylate (referred as HEMA there after) and hexafluorobutyl methacrylate (referred as HFBMA there after). Trimethoxysilylpropylmethacrylate has both a polymerizable methacrylate component and condensable trimethoxysily function. The hydrolysis and condensation of this compound will link it into the silica network, while the polymerization of this compound will link it into the PMA phase. In principle this cross-linker will act as a hook between the silica network and polymethacrylate linear polymer. Inducing gelation of metal oxide or metal oxide/polymer sols in alcohol solutions is referred to as the alcogel process in the present description. Preparation of silica-polymethacrylate hybrid aerogels is described in published US patent application US 2005-0192366 A1 hereby incorporated by reference.

Sols can further be doped with solids (IR opacifiers, sintering retardants, microfibers) that influence the physical and mechanical properties of the gel product. Suitable amounts of such dopants generally range from about 1 to 40% by weight of the finished composite, preferably about 2 to 30% using the casting methods of this invention. IR opacifiers include B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

Major variables in the inorganic aerogel formation process include the type of alkoxide, solution pH, and alkoxide/alcohol/water ratio. Change of the variables can permit control of the growth and aggregation of the matrix species throughout the transition from the “sol” state to the “gel” state. It is useful to be able to control this transition precisely. While properties of the resulting aerogels are strongly affected by the pH of the precursor solution and the molar ratio of the reactants, any pH and any molar ratio that permits the formation of gels may be used in embodiments of the present invention.

Generally, the solvent will be a lower alcohol, i.e. an alcohol having 1 to 6 carbon atoms, preferably 2 to 4, although other liquids known in the art can be used. Examples of other useful liquids include but are not limited to: ethyl acetate, ethyl acetoacetate, acetone, dichloromethane, and the like.

For convenience, the alcogel process for forming inorganic silica gels and composites are described below to illustrate how to create the precursors utilized by embodiments of the present invention, though this is not intended to limit the present invention to any specific type of gel. The invention is applicable to other gel compositions.

Alternatively, other sol preparation and gel induction methods can be utilized to make a precursor gel article using the processing methods presently described. For example, a water soluble, basic metal oxide precursor can be neutralized by an aqueous acid in a continuous fashion, deposited onto a moving dispensing medium, as droplets, as shown in FIG. 1, and induced to make a gel beads on the flowing silicone oil. Sodium silicate has been widely used as a gel precursor. Salt by-products may be removed from the silicic acid precursor by ion-exchange and/or by washing subsequently formed gels with water after formation and mechanical manipulation of the gel.

After identification of the gel material to be prepared using the methods of this invention, a suitable metal alkoxide-alcohol solution is prepared. For producing silica gel beads useful in the manufacture of silica aerogel materials, preferred ingredients are tetraethoxysilane (TEOS), water, and ethanol (EtOH). The preferred ratio of TEOS to water is about 0.2-0.5:1, the preferred ratio of TEOS to EtOH is about 0.02-0.5:1, and the preferred pH is about 2 to 9. The natural pH of a solution of the ingredients is about 5. For producing PMA/silica hybrid gel beads useful in the manufacture of PMA/silica hybrid aerogel beads, trialkoxysilyl-containing polymethacrylate oligomer was added, together with the above mentioned silica precursor, water and solvents. The following catalysts can be used to change the pH of the sol and to bring it into gelation. While any acid may be used to obtain a lower pH solution, HCl, H₂SO₄ or HF are preferred. To generate a higher pH, a base like NaOH, KOH or NH₄OH can be used. Depending on the amount of catalyst used, the silica or hybrid sol can gel between 1 second to 1 day, preferably between 3 seconds to 1 minute.

The resulting silica aerogel beads and PMA/silica aerogel beads may have a packing density between 0.05 to 0.25 g/cm³, and thermal conductivity between about 11 to about 25 mW/mK or between about 15 to 21 mW/mK. Depending of the method, the diameter of the beads are between about 0.01 mm to about 10 mm or between about 1 mm to about 3 mm or between about 0.01 mm to about 0.1 mm or between about 1 to about 3 mm or between about 0.1 to about 0.3 mm. In one embodiment, the dispensing medium is non-miscible with the sol and chemically inert thereto. The dispensing medium is also a polyorganosiloxane or a liquid with a density between about 0.85 to about 1.1 or a liquid with viscosity between 1 and 100 cSt or any combination thereof.

In one embodiment the beads are separated from the dispensing medium with a separation means such as screen mesh, sieve, or a semi permeable membrane. Furthermore the separation means is constructed to continuously receive and dispense the beads while the dispensing medium accompanying the same is flowed through the separation means. For example a mesh conveyor belt to receive the beads after they exit the trough can separate the residual dispensing medium from the beads while continuously transferring the beads away from the apparatus. This may be used further automate the gel preparation method. There may also be a significant advantage from a horizontally flowing dispensing medium, since a vertically flowing dispensing medium may face more difficulties in carrying out the same step.

In one embodiment the diameter of the beads produced is between about 0.01 mm to about 10 mm or between about 1 mm to about 3 mm or between about 0.01 mm to about 0.1 mm.

In an embodiment of the present invention, the catalyzed sol droplet is completely formed before it is deposited into the dispensing medium. This is achieved by simply spacing the dispensing nozzle from the dispensing medium such that the droplet completely forms before contacting the dispensing medium.

In another embodiment the catalyzed sol droplets are suspended in the dispensing medium between the time of deposition into and the time of removal from said dispensing medium. Stated differently, the beads neither float on top nor sink to the bottom of the dispensing medium. This may be achieved by adjusting the relative density between the catalyzed sol droplet and the dispensing medium. Other factors such as viscosity, surface tension, temperature of medium, and flow characteristics of the medium may also be adjusted to enhance the suspension of droplets or beads.

Further details and explanation of the present invention may be found in the following non-limiting examples, which describe the manufacture of the silica aerogel beads and polymer/silica hybrid aerogel beads in accordance with embodiments of the present invention and test results generated there from. All parts and percents are by weight unless otherwise specified.

The embodiments of the present invention can be further illustrated by way of the following examples. These examples are in no way a limitation to the scope of the present invention and are for illustration purposes only

### EXAMPLE 1

This example illustrates the formation of silica aerogel beads opacified with 5 weight percent loadings of carbon black. 7.07 kg of silica precursor was mixed with 9.78 kg ethanol and 1.57 kg for 1 hour at ambient conditions. It is then charged into a pressure container as a hydrolyzed sol. 6.75 kg of 28-30% aqueous base was mixed with 1.98 kg of ethanol and 130 Alcoblack® for 10 minutes. It is then charged into another pressure container as catalyst. The sol and catalyst were mixed together in a 2 to 1 ratio by a nozzle and dropped into the flowing silicone oil. A stream of compressed air was injected along the sol droplets, leading to a sol spray before entering the silicone oil. The resulting sol micro droplets flow slowly with the silicone oil toward the end of the vessel and downward into the collection bag. Collected beads can be removed periodically. After removing the excess amount of silicone oil, the bags of gel beads are sent through a silylation step and dried by CO₂ supercritical extraction. The obtained opacified silica aerogel micro beads have typical diameter between 0.1 to 0.3 mm, packing density at 0.06 g/cm3 and thermal conductivity of 16.9 mW/mK.

### EXAMPLE 2

This example illustrates the formation of 1 to 3 mm size PMMA/silica aerogel beads with 15% loading of PMMA. 0.90 g of ter-butyl peroxy-2-ethyl hexanoate was added to a mixture of 40 g of MMA, 24.8 g of TMSPM and 18.3 g of methanol, following by vigorous stirring at 70 to 80° C. for 0.5 hr Trimethoxysilyl containing polymethacrylate oligomer was obtained as a viscous liquid in concentrated ethanol solution. 41.16 g trimethysilyl containing polymethacrylate oligomer was mixed with 829.6 g of Silica precursor, 207.9 g of ethanol, 93.8 g of water and 56.1 g of 0.1M aqueous HCl for 1 hour at ambient conditions. It is then charged into a pressure container as hydrolyzed sol. 34.7 g of 28-30% aqueous base was mixed with 261.3 g of ethanol and 330.7 g of water for 10 minutes. It is then charged into another pressure container as catalyst. The sol and catalyst were mixed together in a 2 to 1 ratio by a nozzle and dropped into the flowing silicone oil. The resulting sol droplets flow slowly with the silicone oil toward the end of the vessel and downward into the collection bag. Collected beads can be removed periodically. After removing the excess amount of silicone oil, the bags of gel beads sent through a silylation step and dried by CO2 supercritical extraction. The obtained PMMA/silica aerogel beads have typical diameter between 1 to 3 mm, packing density at 0.123 g/cm3 and thermal conductivity of 21.2 mW/mK. Maximum compression failure load for this hybrid aerogel bead (in 2 mm diameter) is about 0.93 kg.

What is claimed is:

1. A method for producing gel beads comprising:
depositing catalyzed sol droplets comprising a gel precursor into a dispensing medium, said dispensing medium being immiscible with the sol, and
allowing gelation of the sol to occur in the moving dispensing medium thereby producing gel beads.

2. The method of claim 1 wherein the sol droplet is deposited in a horizontally flowing dispensing medium.

3. The method of claim 2 wherein the sol droplets are continuously or intermittently deposited in the medium.

4. The method of claim 2 wherein the density of the medium is greater than the density of the sol droplet.

5. The method of claim 2 wherein the density of the medium is between about 0.85 g/cm³ and about 1.1 g/cm³ preferably between about 0.9 g/cm³ and about

6. The method of claim 2 wherein the beads comprise an inorganic compound.

7. The method of claim 6, wherein the inorganic compound comprises a material selected from the group consisting of zirconia, yttria, hafnia, alumina, titania, ceria, and silica, magnesium oxide, calcium oxide, magnesium fluoride, calcium fluoride, and combinations thereof

8. The method of claim 2 wherein the beads comprise an organic-inorganic compound.

9. The method of claim 8, wherein the inorganic-organic compound comprises a material selected from any combination of group 1 with group 2 wherein group 1 comprises zirconia, yttria, hafnia, alumina, titania, ceria, and silica, magnesium oxide, calcium oxide, magnesium fluoride and calcium fluoride and group 2 comprises polyacrylates, polyolefins (including thermoplastics and rubber materials), polystyrenes, polyacrylonitriles, polyurethanes, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, and combinations thereof.

10. The method claim 2, wherein the sol droplets dispensed into the flowing liquid medium in through a nozzle.

11. The method of claim 2, wherein a stream of air or oil is in contact with the sol droplet prior to deposition thereof.

12. The method of claim 15 wherein the stream of air or oil causes the sol droplet to form into a plurality of smaller droplets.

13. The process of claim 2, wherein the medium flows horizontally and moves the beads away from the sol droplet depositing zone.

14. The process of claim 2, wherein the medium is immiscible with the sol thereby resulting in a spherical shape of the resulting gel beads.

15. The process of claim 2, wherein the liquid medium is a polyorganosiloxane.

16. The process of claim 2, wherein the gelation is induced by dissipation of a sufficient amount of energy into a cross-sectional area of the sol droplets.

17. The process of claim 16, wherein the energy source is electromagnetic in origin, such as infrared, x-ray, microwave, gamma ray and the like.

18. The process of claim 16, wherein the energy source is a particle beam, such as an electron beam, beta particle, or alpha particle radiation source.

19. The method of claim 2 wherein the beads are spherical and have a diameter between about 10 micrometers to about 100 micrometers.

20. The method of claim 2 wherein the beads are spherical and have a diameter above about 100 micrometers.
